(19) United States
(12) Patent Application Publication
(10) Pub. No.: US 2014/0350855 A1
(43) Pub. Date: Nov. 27, 2014

(54) Systems and Methods for Providing Navigational Assistance to Reserved Parking Locations

(71) Applicant: Sashanka Vishnuvajhala, San Jose, CA (US)

(72) Inventor: Sashanka Vishnuvajhala, San Jose, CA (US)

(73) Assignee: GOOGLE INC., Mountain View, CA (US)

(21) Appl. No.: 13/407,122

(22) Filed: Feb. 28, 2012

(51) Int. Cl. G01C 21/00; G06Q 50/10

(52) U.S. Cl. 701/538; 705/5

(57) ABSTRACT

A computer-implemented method that includes reserving a first parking location for parking of a first vehicle, determining that the first vehicle is parked in a second parking location that is different from the first parking location reserved for parking of the first vehicle, determining, using a computer, whether the second parking location is available for parking of the first vehicle, and in response to at least determining that the second parking location is not available for parking of the first vehicle, providing for display of a prompt requesting that the first vehicle be moved to a parking location that is available for parking of the first vehicle.

### BACKGROUND OF THE INVENTION

1. Field of the Invention

This invention relates generally to providing assistance in locating available parking and more particularly to locating and providing navigational assistance to available parking locations.

2. Description of the Related Art

When traveling to a destination users often desire to park their vehicle at or near the destination. For example, after driving to at a shopping mall, a driver typically desires to park their vehicle in a parking facility (e.g., a parking lot) that is at or near the shopping mall. Unfortunately, parking facilities are often crowded with a large number of vehicles, making it difficult for users to find a suitable parking space. As a result, users often have to drive through various portions of a parking facility to locate a suitable parking space. For example, a user may have to circle through a parking facility several times or more to find an open parking space. The search for a parking space can result in an expenditure of the user's time, increased fuel consumption and general frustration of the user.

In attempt to assist users with finding a suitable location for parking, systems have been developed that attempt to monitor the status of available parking. Unfortunately, these systems may provide static parking information that may not accurately reflect continuous changes in parking availability. Moreover, these systems may have difficulty in tracking where users eventually park their vehicle, making it difficult for the systems to provide accurate parking information to other users.

### SUMMARY OF THE INVENTION

Various embodiments of methods and apparatus for providing navigational assistance to available parking locations are provided herein. In some embodiments, provided is a computer-implemented method that includes reserving a first parking location for parking of a first vehicle, determining that the first vehicle is parked in a second parking location that is different from the first parking location reserved for parking of the first vehicle, determining, using a computer, whether the second parking location is available for parking of the first vehicle, and in response to at least determining that the second parking location is not available for parking of the first vehicle, providing for display of a prompt requesting that the first vehicle be moved to a parking location that is available for parking of the first vehicle.

In some embodiments, provided is a computer-implemented method that includes receiving a request for navigational assistance to a given location, determining whether there are one or more parking spaces available at a parking facility associated with the given location, the parking facility allowing for reservation for parking of a vehicle within an available parking space prior to arrival of the vehicle at the location, and in response to at least determining that there is one or more parking spaces available at the parking facility, providing for display of an option to reserve at least one of the one or more parking spaces determined to be available at the parking facility.

In some embodiments, provided is a computer-implemented method that includes receiving, from a mobile communications device, an indication that a vehicle is parked in a parking space of a parking facility, determining that a fee is paid to entitle parking of the vehicle within the parking space until a parking expiration time, determining a parking expiration alert time, the parking expiration alert time occurring a given amount of time prior to the parking expiration time, determining that a current time is equal to or greater than the parking expiration time, and in response to determining that a current time is equal to or greater than the parking expiration time, providing for display via the mobile communications device, a parking expiration alert indicative of the parking expiration time and providing an option to authorize a payment of an additional fee to entitle parking of the vehicle within the parking space until an extended parking expiration time that is later then the parking expiration time.

### BRIEF DESCRIPTION OF THE DRAWINGS

FIG. 1 is a diagram that illustrates an exemplary parking system in accordance with one or more embodiments of the present technique.

FIG. 2 is a diagram that illustrates an exemplary parking facility in accordance with one or more embodiments of the present technique.

FIG. 3 is a table that illustrates an exemplary parking status listing in accordance with one or more embodiments of the present technique.

FIGS. 4A-4C include various portions of a flowchart that illustrates a method of providing navigational assistance to a reserved parking space in accordance with one or more embodiments of the present technique.

FIG. 5 is a diagram that illustrates an exemplary parking request page in accordance with one or more embodiments of the present technique.

FIG. 6 is a diagram that illustrates an exemplary parking availability page in accordance with one or more embodiments of the present technique.

FIG. 7 is a diagram that illustrates an exemplary navigational page in accordance with one or more embodiments of the present technique.

FIG. 8 is a diagram that illustrates an exemplary parking confirmation page in accordance with one or more embodiments of the present technique.

FIG. 9 is a diagram that illustrates an exemplary payment request page in accordance with one or more embodiments of the present technique.

FIG. 10 is a diagram that illustrates an exemplary parking options page in accordance with one or more embodiments of the present technique.

FIG. 11 is a diagram that illustrates an exemplary move request page in accordance with one or more embodiments of the present technique.

FIG. 12 is a diagram that illustrates an exemplary parking expiration alert page in accordance with one or more embodiments.

FIG. 13 is a flowchart that illustrates a method of providing parking expiration alerts in accordance with one or more embodiments of the present technique.

FIG. 14 is a diagram that illustrates an exemplary parking return page in accordance with one or more embodiments.

FIG. 15 is a flowchart that illustrates a method of providing navigational assistance to a parking space in accordance with one or more embodiments of the present technique.

FIG. 16 is a diagram that illustrates an exemplary computer system in accordance with one or more embodiments of the present technique.

### DETAILED DESCRIPTION OF THE PREFERRED EMBODIMENTS

As discussed in more detail below, provided in some embodiments are systems and methods for providing navigational assistance for directing users to available parking locations. In some embodiments, a user may submit a request for navigational assistance to a destination via a mobile communications device such as a navigation unit (e.g., a portable navigation device or an in-vehicle navigation device), a cellular phone, a personal digital assistant (PDA) or the like. In certain embodiments, a parking system may identify whether a parking facility including monitored parking is located at or near the destination. In some embodiments, upon determining that monitored parking is located at or near the destination, the parking system may identify available parking and/or provide the user with an option to request/reserve parking. In certain embodiments, the parking system may provide the user with an option to reserve an available parking space prior to their arrival at the parking facility and/or the parking space. In some embodiments, the parking system may provide the user an option to select from a plurality of available parking spaces that are available at the parking facility. In certain embodiments, the parking system may provide the user with various types of information relating to the parking space(s) (e.g., size, location, fee, or the like) such that the user may make an informed decision as to which parking space they would like to reserve. In some embodiments, the parking system may provide navigational assistance to direct the user to a parking space reserved by the user.

In some embodiments, the parking system may monitor a status of the parking space reserved by the user as the user navigates to the reserved parking space (e.g., prior to the user's arrival at the parking facility and/or the reserved parking space) to determine whether or not the reserved parking space remains available. In certain embodiments, upon determining that the reserved parking space is no longer available (e.g., another vehicle has illegally parked in the reserved parking space), the parking system may locate one or more other parking spaces that are available and may provide the user with an option to reserve one of the other parking space(s) that are available. In some embodiments, upon selection/reservation of another parking space, the parking system may provide navigational assistance to direct the user to the other parking space selected/reserved.

In certain embodiments, upon the user's vehicle being parked, a parking system may determine whether or not the user's vehicle is parked in the parking space reserved by the user. In some embodiments, where it is determined that the user's vehicle is parked in the parking space reserved by the user, the parking system may provide the user with various options/information relating to the parking space (e.g., an option to pay for the parking space) and/or update a status of the parking space to reflect the user's vehicle being parked in the parking space. In some embodiments, where it is determined that the user's vehicle is not parked in the parking space reserved by the user, but is instead parked in an unreserved parking space that is available for parking of the user's vehicle (e.g., parked in an unreserved/available parking space), the parking system may provide the user with the option to change their reservation to the parking space in which their vehicle is currently parked, to move to their vehicle to the parking space previously reserved by the user and/or to cancel their reservation. In certain embodiments, upon the user's selection to remain in a previously unreserved/available parking space, the parking system may provide the user with various options/information relating to the parking space (e.g., an option to pay for the parking space) and/or update a status of the parking space as being occupied by the user's vehicle. In some embodiments, where it is determined that the user's vehicle is not parked in the parking space reserved by the user, but is instead parked in a reserved parking space that is not available for parking (e.g., a parking space that is already reserved by another user), the parking system may prompt the user to move their vehicle from the current parking space. In certain embodiments, the parking system may prompt the user to move their vehicle to the parking space reserved by the user, an unreserved/available parking space, and/or cancel their reservation.

In some embodiments, the parking system may monitor a time at which authorization for the user's vehicle to be parked in the parking space is set to expire and, at or near the time of expiration of authorization (e.g., a parking expiration time), provide an alert regarding the expiration and/or an option to extend the parking reservation. In certain embodiments, the user may be provided an opportunity to extend their parking reservation via a mobile communications device such that they do not have to return to the physical location of the parking facility and/or the parking space to pay for or otherwise extend the parking reservation.

In some embodiments, the parking system may provide directions to assist a user in returning to their vehicle. In certain embodiments, providing directions to assist a user in returning to their vehicle may include providing a navigational map or similar guidance that directs the user to the location where their vehicle is currently parked (e.g., the reserved parking space). In some embodiments, directions to assist the user in returning to their vehicle may be provided via a user interface of the user's mobile communications device such that the user may rely on the directions as they return to their vehicle.

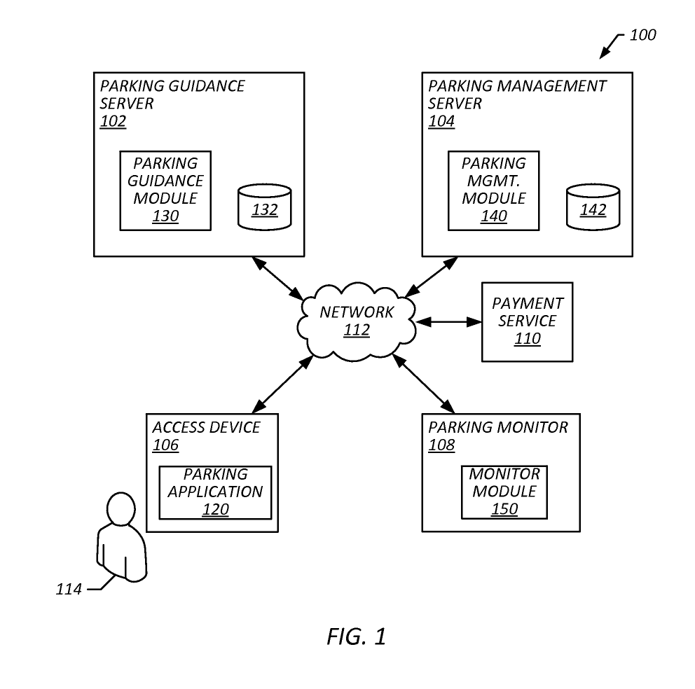

FIG. 1 is a diagram that illustrates an exemplary parking system (“system”) 100 in accordance with one or more embodiments of the present technique. As depicted, system 100 may include a parking guidance server 102, a parking management server 104, an access device 106, a parking monitor 108 and a payment service 110. Entities of system 100 may be communicatively coupled via a network 112.

Network 112 may include any element or system that facilitates communications between the entities of system 100. For example, network 112 may facilitate communication between parking guidance server 102, parking management server 104, access device 106, parking monitor 108 and/or payment service 110. Network 112 may include an electronic communications network, such as the Internet, a local area network (LAN), a wide area (WAN), a cellular communications network or the like. Network 112 may facilitate data exchange by way of packet switching using the Internet Protocol (IP). Network 112 may facilitate wired and/or wireless connectivity and communication. Network 112 may include a single network or combination of networks that facilitate communication between entities of system 100.

Payment service 110 may include an entity that provides for funding, collecting or otherwise secure payments. Payment service may facilitate the transfer of funds from payor's account to a payee's account. For example, where user 112 requests to submit a payment for a parking space of a parking facility, payment service 110 may coordinate a transfer of funds from an account associated with user 112 to an account associated with the parking facility. In some embodiments, payment service 110 may include a network entity that facilities payments and/or money transfers to be made through the Internet or a similar network.

Access device 106 may be capable of transmitting and/or receiving information via network 112. Access device 106 may be employed by a user 114 to interact with other entities coupled to network 112. Access device 106 may include one or more of a personal computer (e.g., a desktop computer), a mobile computing device (e.g., a laptop or tablet computer), a cellular communication device (e.g., a cellular phone), a personal digital assistant (PDA), a media player/recorder, a game console, a television system, an audio system, a radio system, a navigation system, or the like. Access device 106 may include a mobile communications device capable of being coupled to network 112 via a cellular communications network or similar wireless network. For example, access device 106 may include a portable navigation device, an in-vehicle navigation device, a cellular phone, a personal digital assistant (PDA), a laptop computer, a tablet computer, or similar mobile computing device capable of wireless and/or wired communication with parking guidance server 102, parking management server 104 and/or payment server 110 via network 112.

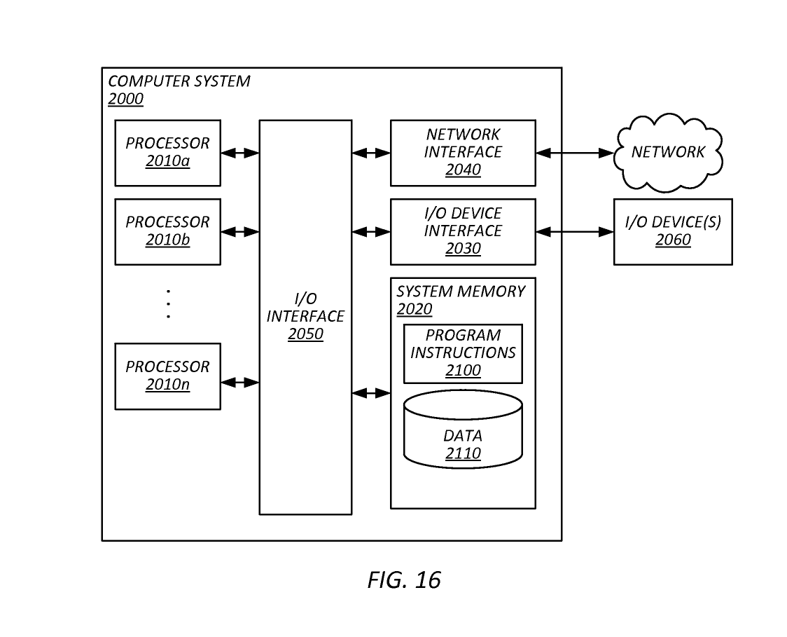

Access device 106 may include various input/output (I/O) interfaces such as a graphical user interface (e.g., display screen), an audible output user interface (e.g., speaker), a keyboard, a pointer device (e.g., mouse, trackball, touchpad, stylus or the like), an audible input user interface (e.g., microphone), a printer, or the like. In some embodiments, access device 106 may include a computer system similar to that of computer system 2000 described below with regard to at least FIG. 16.

Access device 106 may include general computing components and/or embedded systems optimized with specific components for performing specific tasks. Access device 106 may include a program/application that can be used to generate a request for content, to provide content, to render content, and/or to send/receive request to other devices via network 112. For example, access device 106 may employ a parking application 120. Parking application 120 may be implemented via an Internet web-browser or other application executed by access device 106. In some embodiments, application 120 may include a module including program instructions that are executable by a computer system to perform some or all of the functionality described herein with regard to access device 106. Application 120 may be used to transmit and/or receive data and/or content via network 112, process data, render data/content for display via a graphical user interface of access device 106, and/or enable user interaction with data and/or content via a user interface of access device 106.

Parking guidance server 102 may include a server or similar device/system for processing and/or serving client requests for parking assistance, geographic maps, and/or related data. In some embodiments, parking guidance server 102 may include a computer system similar to that of computer system 2000 described below with regard to at least FIG. 16. Although parking guidance server 102 is represented by a single box, parking guidance server 102 may include a single server or similar system, or a plurality of servers and/or similar systems. For example, parking guidance server 102 may include a plurality of different servers and/or similar systems that may be employed individually or in combination to perform some or all of the functionality described herein with regard to parking guidance server 102. In some embodiments, a plurality of servers and/or similar systems may be employed in combination to provide load balancing (e.g., distributing processing tasks between the plurality of servers and/or similar systems).

In some embodiments, parking guidance server 102 may include a parking guidance module 130. Parking guidance module 130 may include program instructions that are executable by a computer system to perform at least some or all of the functionality described herein with regard to at least parking guidance server 102. In some embodiments, parking guidance module 130 may provide for processing and serving requests for parking assistance, geographic maps, and/or related data. For example, parking guidance module 102 may include an application that provides for serving, to access devices, navigational assistance for directing users to reserved/available parking locations.

In some embodiments, parking guidance server 102 may include or otherwise have access to a datastore 132. Datastore 132 may include a database and/or other memory locations for storing data. In some embodiments, parking guidance module 130 may be stored at datastore 132. In some embodiments, data used for processing and/or serving requests, such as maps, parking status listings, and/or the like, may be stored at datastore 132.

Parking management server 104 may include a server or similar device/system for processing and serving client requests for parking information and/or related data. In some embodiments, parking management server 104 may include a computer system similar to that of computer system 2000 described below with regard to at least FIG. 16. Although parking management server 104 is represented by a single box, parking management server 104 may include a single server or similar system, or a plurality of servers and/or similar systems. For example, parking management server 104 may include a plurality of different servers and/or similar systems that may be employed individually or in combination to perform some or all of the functionality described herein with regard to parking management server 104. In some embodiments, a plurality of servers and/or similar systems may be employed in combination to provide load balancing (e.g., distributing processing tasks between the plurality of servers and/or similar systems).

In some embodiments, parking management server 104 may include parking management module 140. Parking management module 140 may include program instructions that are executable by a computer system to perform at least some or all of the functionality described herein with regard to at least parking management server 104. In some embodiments, parking management module 140 may provide for processing and serving requests for parking availability information and related data. For example, parking management module 104 may include an application or similar processing environment that provides for collecting and/or processing of parking availability information, and/or serving parking availability information to parking guidance server 102.

In some embodiments, parking management server 104 may include or otherwise have access to a datastore 142. Datastore 142 may include a database and/or other memory locations for storing data. In some embodiments, parking management module 140 may be stored at datastore 142. In some embodiments, data used for processing and/or serving requests, such as parking status listings, parking status updates, and/or the like, may be stored at datastore 142.

Parking monitor 108 may include a system that provides for monitoring parking availability at one or more parking facilities. In some embodiments, parking monitor 108 may provide parking status updates that are indicative of availability of one or more parking spaces within a parking facility. In some embodiments, parking status updates provided by parking monitor 108 may be employed by parking guidance server 102 and/or parking management server 104 to generate a parking status listing, or similar data structure, that is indicative of the parking status for some, substantially all or all of the parking spaces of a parking facility.

In some embodiments, parking monitor 108 may include monitor module 150. Monitor module 150 may include program instructions that are executable by a computer system to perform at least some or all of the functionality described herein with regard to at least parking monitor 108. In some embodiments, monitor module 150 may provide for processing and/or serving requests for parking status information and related data. For example, monitor module 150 may include an application that provides for collecting parking status information and/or serving parking status information to parking guidance server 102 and/or parking management server 104. In some embodiments, parking monitor 108 may include a computer system similar to that of computer system 2000 described below with regard to at least FIG. 16.

In some embodiments, parking guidance server 102, parking management server 104, access device 106, parking monitor 108 and/or payment service 110 may include separate entities that are located remotely from one another on network 112. Although certain exemplary embodiments described herein refer to certain processes being performed on a given device/system (e.g., parking guidance server 102, parking management server 104, access device 106, parking monitor 108 and/or payment service 110), embodiments may include the described techniques being performed by any suitable entity or combination of entities. For example, parking guidance server 102 may provide for some or all of the functionality described with regard to parking management server 104.

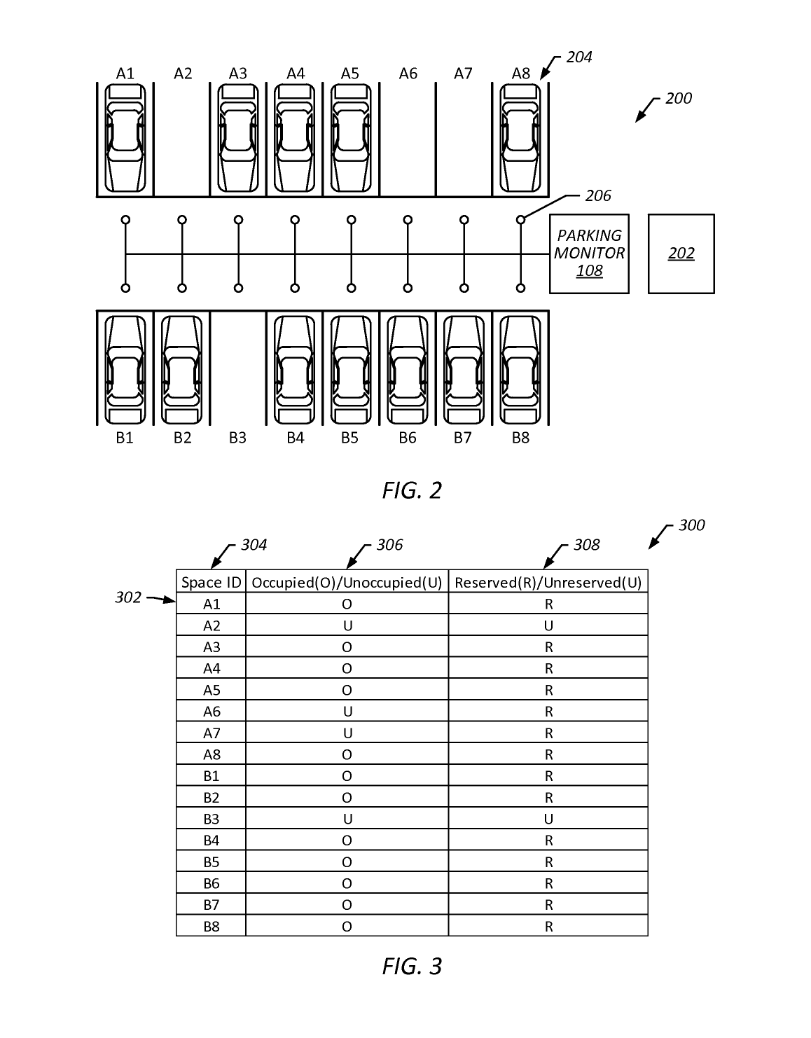

FIG. 2 is a diagram that illustrates an exemplary parking facility 200 in accordance with one or more embodiments of the present technique. Parking facility 200 may include a location for parking vehicles at or near a geographic place of interest (e.g., destination) 202. For example, parking facility 200 may include a parking lot at or near a shopping mall, a store, an office building, a sports stadium, or the like.

In some embodiments, parking facility 200 may include any number of parking spaces 204. For example, in the illustrated embodiment, parking facility 200 includes sixteen individual parking spaces 204. In some embodiments, each parking space 204 may be suitable for the parking of a single vehicle therein.

In some embodiments, parking facility 200 may include parking monitor 108. Parking monitor 108 may provide for monitoring of parking availability at parking facility 200. For example, parking monitor 108 may be employed to monitor a status of one or more of parking spaces 204 of parking facility 200. In some embodiments, parking monitor 108 may provide parking status updates that are indicative of availability of one or more of parking spaces 204 of parking facility 200. For example, when a vehicle enters or exits a given parking space 204 of parking facility 200, parking monitor may 108 provide, to parking guidance server 102 and/or parking management server 104, a corresponding parking status update indicative of the status of the given parking space 204 (e.g., occupied or unoccupied). In some embodiments, parking guidance server 102 and/or parking management server 104 may employ parking status updates to determine a current status of each of parking spaces 204 of parking facility 200. For example, upon receiving a parking status updates indicative of a given parking space 204 being occupied by a vehicle, parking guidance server 102 and/or parking management server 104 may update a corresponding parking status listing to reflect the given parking space being occupied.

In some embodiments, parking monitor 108 may include one or more parking status sensors 206. Parking status sensors 206 may provide for detecting parking availability/status of one or more parking spaces 204. For example, parking monitor 108 may employ a plurality of sensors 206 that detect whether individual parking spaces 204 of parking facility 200 are occupied or unoccupied. In some embodiments, parking status sensors 206 may include proximity sensors, image sensors, and/or the like for detecting the physical presence of vehicles in corresponding parking spaces 204 of parking facility 200. In some embodiments, parking status sensors 206 may be provided at some, substantially all, or all of the parking spaces of a parking facility such that a parking monitor is capable of providing parking status information for some, substantially all, or all of the parking spaces of the parking facility.

A given parking status sensor 206 may provide, to parking monitor 108, an indication that a given parking space 204 is occupied when the given parking status sensor 206 detects a vehicle physically parked within the given parking space 204. A given parking status sensor 206 may provide, to parking monitor 108, an indication that a given parking space 204 is unoccupied when the given parking status sensor 206 detects that a vehicle is not physically parked within the given parking space 204.

In some embodiments, a parking status update may specify a parking status. For example, a parking status corresponding to parking space “A1” of parking facility 200 may including the string “A1:O” indicative of parking space “A1” being occupied. As a further example, a parking status update corresponding to parking space “A2” of parking facility 200 may including the string “A2:U” indicative of parking space “A2” being unoccupied.

In some embodiments, parking monitor 108 may forward parking status updates on a substantially regular basis. For example, parking monitor 108 may forward parking status updates on a regular basis to enable parking guidance server 102 and/or parking management server 104 to maintain an updated parking status listing. In some embodiments, parking monitor 108 may forward parking status updates on a periodic basis. For example, parking monitor 108 may forward parking status updates to parking server 104 about every one second, five seconds, thirty seconds, one minute, five minutes, ten minutes, or any suitable frequency. In some embodiments, parking monitor 108 may forward parking status updates indicative of one or more changes in parking status in response to detecting the one or more changes in parking status. For example, upon receiving an indication that parking space “A2” has been occupied by a vehicle, parking monitor 108 may forward, to parking server 104, a parking status update indicative of parking space “A2” being occupied. In some embodiments, parking status updates may be transmitted automatically. For example, parking monitor 108 may push parking status updates to parking server 104 (e.g., without being requested by parking server 104). In some embodiments, parking status updates may be transmitted in response to a request for parking status updates. For example, parking monitor 108 may queue parking status updates and may transmit them to parking server 104 in response to receiving one or more corresponding queries for parking status updates.

FIG. 3 is a table that illustrates an exemplary parking status listing 300 in accordance with one or more embodiments of the present technique. Parking status listing 300 may provide of a parking status for each parking space 204 of parking facility 200 of FIG. 2. In the illustrated embodiment, parking status listing 300 includes a plurality of entries 302 that each specifying a space identifier (ID) 304, a parking status 306 and a reservation status 308. Although parking status listing 300 is illustrated as a table, a parking status listing may include any suitable data structure.

In some embodiments, space ID 304 may include a unique identifier associated with a corresponding parking space. For example, space ID's “A1”-“B8” may correspond to respective parking spaces “A1”-“B8” of parking facility 200.

In some embodiments, parking status 306 may reflect a current parking status of a corresponding parking space 204. For example, a parking status of “O” may be provided in association with parking spaces 204 of parking facility 200 that are occupied (e.g., having a vehicle parked therein) and a parking status of “U” may be provided in association with parking spaces 204 of parking facility 200 that are unoccupied (e.g., that do not have a vehicle parked therein).

In some embodiments, reservation status 308 may reflect a current reservation status of a corresponding parking space 204. For example, a reservation status of “R” may be provided in association with parking spaces 204 of parking facility 200 that are reserved (e.g., an unoccupied space that is reserved for a user to park their vehicle therein and/or currently having a vehicle parked therein) and a reservation status of “U” may be provided in association with parking spaces 204 of parking facility 200 that are unreserved (e.g., an unoccupied space that is not reserved for a user to park their vehicle therein.

In some embodiments, parking status listing 300 may be generated based on parking status updates received from parking monitor 108. For example, parking status 306 and reservation status 308 for each of entries 302 may be based on a most recently received parking status update for the corresponding parking space 204. In some embodiments, parking status listing 300 may be continually updated based on received parking status updates. For example, upon a vehicle being parked in parking space “A2” of parking facility 200, parking monitor may forward a corresponding parking status update including the string “A2:O” indicative of parking space “A2” being occupied, and parking status listing 300 may be updated accordingly (e.g., parking status 306 of the entry 302 corresponding to parking space “A2” may be changed from “U” to “O” and reservation status 308 of the entry 302 corresponding to parking space “A2” may be changed from “U” to “R”).

In some embodiments, a parking status listing 300 may be maintained by parking management server 104. For example, parking management listing 300 may be stored in datastore 142 of parking management server 104 and may be updated based on parking status updates received from parking monitor 108. In some embodiments, a copy of parking status listing 300 may be provided to parking guidance server 102. For example, parking management server 104 may transmit a copy of a current/updated version of parking status listing 300 to parking guidance server 102. Parking guidance server 102 may store the current/updated version of parking status listing 300 in datastore 132.

In some embodiments, parking management server 104 may forward an updated copy of parking status listing 300 on a substantially regular basis. For example, parking management server 104 may forward a current/updated version of parking status listing 300 on a regular basis to enable parking guidance server 102 to maintain a substantially current/updated parking status listing. In some embodiments, parking management server 104 may forward a current/updated version of parking status listing 300 on a periodic basis. For example, parking management server 104 may forward a current/updated version of parking status listing 300 to parking guidance server 102 about every one second, five seconds, thirty seconds, one minute, five minutes, ten minutes, or any suitable frequency. In some embodiments, parking management server 104 may forward a current/updated version of parking status listing 300 indicative of one or more changes in parking status in response to detecting the one or more changes in parking status. For example, upon receiving a parking status update indicative of parking space “A2” being occupied by a vehicle, parking management server 104 may update parking status listing 300 to reflect the change, and forward, to parking guidance server 102, a current/updated version of parking status listing 300 indicative of parking space “A2” being occupied. In some embodiments, current/updated versions of parking status listing 300 may be transmitted automatically. For example, parking management server 104 may push current/updated versions of parking status listing 300 to parking guidance server 102 (e.g., without a corresponding request by parking guidance server 104). In some embodiments, a current/updated version of parking status listing 300 may be transmitted in response to a request for a current/updated version of parking status listing 300. For example, parking management server 104 may transmit a current/updated version of parking status listing 300 to parking guidance server 102 in response to receiving, from parking guidance server 102, a corresponding query for a current/updated version of parking status listing 300. In some embodiments, parking guidance server 102 may update a local copy of a parking status listing based on parking status updates. For example, a parking status listing 300 stored at datastore 132 may be updated based on parking status updates received from parking monitor 108, parking management server 104 and/or access device 106.

In some embodiments, parking guidance server 102 may rely on a local copy of parking status listing 300 for determining parking availability information. For example, upon parking guidance server 102 receiving a query regarding parking availability at parking facility 200, parking guidance server 102 may access the local copy of the current/updated version of parking status listing 300, determine parking availability information based on the local copy of parking status listing 300, and serve corresponding parking availability information. In an exemplary embodiment, in response to receiving, from access device 106, a query for parking availability information relating to parking facility 200, parking guidance server 102 may access a local copy of parking status listing 300 (e.g., similar to that of parking status listing 300 of FIG. 3) stored at datastore 132, determine that parking spaces “A2” and “B3” are unoccupied and unreserved based the on local copy of parking status listing 300, and serve, to access device 106, content indicative of parking spaces “A2” and “B3” being available for reservation. Access device 106 may display, to user 114, corresponding content indicative of parking spaces “A2” and “B3” being available for reservation.

In some embodiments, parking guidance server 102 may query parking management server 104 for parking availability information. For example, upon parking guidance server 102 receiving a query regarding parking availability at parking facility 200, parking guidance server 102 may query parking management server 104 for corresponding parking availability information, receive the corresponding parking availability information from parking management server 104, and serve corresponding parking availability information based at least in part on the corresponding parking availability information received. In an exemplary embodiment, in response to receiving, from access device 106, a query for parking availability information relating to parking facility 200, parking guidance server 102 may forward, to parking management server 104, a corresponding query for parking availability information, parking management server 104 may access a local copy of parking status listing 300 (e.g., similar to that of parking status listing 300 of FIG. 3) stored at datastore 142, parking management server 104 may determine that parking spaces “A2” and “B3” are unoccupied and unreserved based the on local copy of parking status listing 300, parking management server 104 may serve, to parking guidance server 102 parking availability information indicative of parking spaces “A2” and “B3” being available for reservation, and parking guidance server 102 may serve, to access device 106 corresponding content indicative of parking spaces “A2” and “B3” being available for reservation. Access device 106 display, to user 114, the corresponding content indicative of parking spaces “A2” and “B3” being available for reservation.

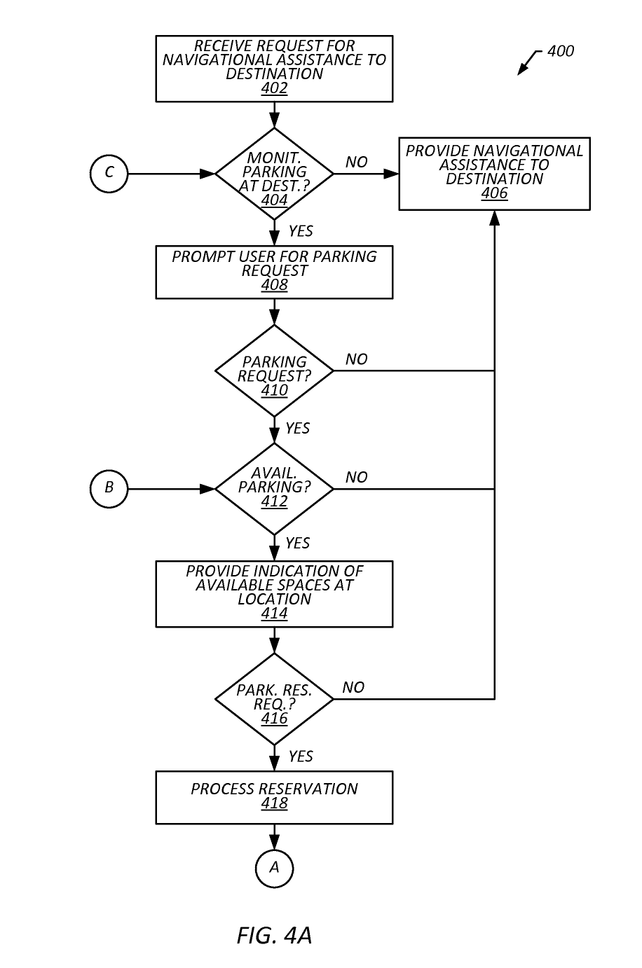

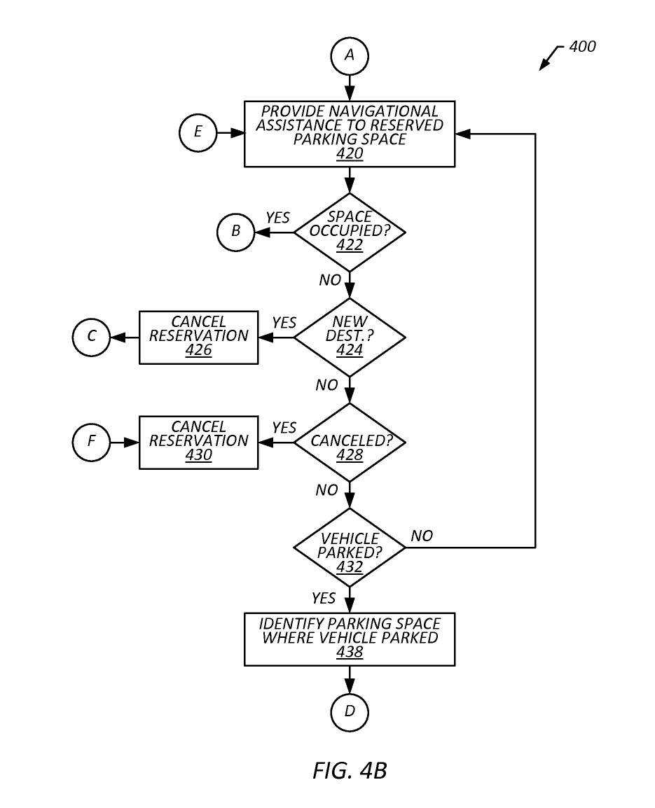

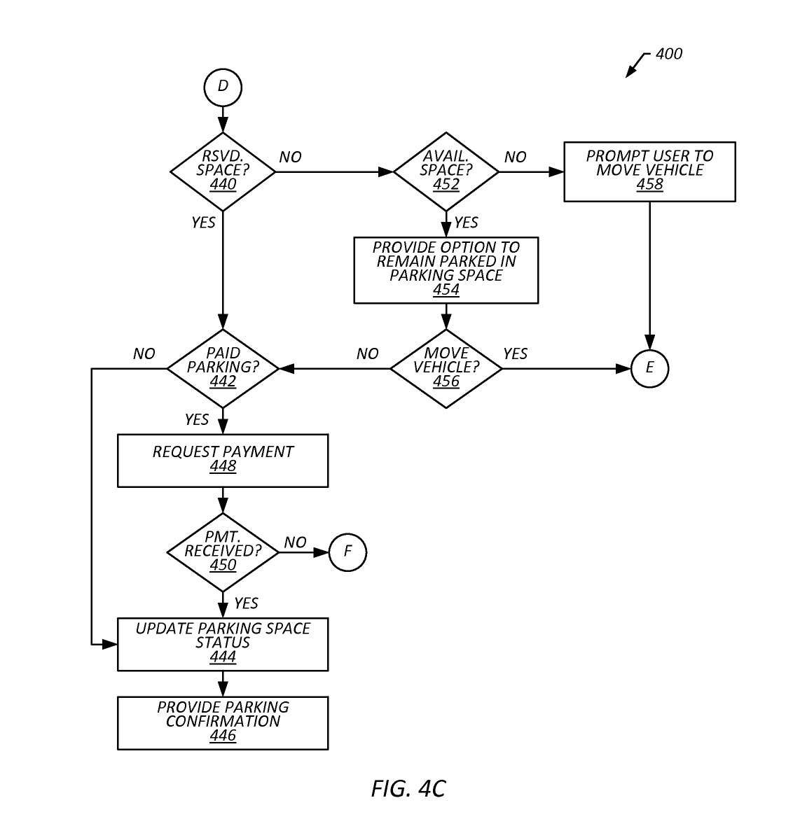

FIGS. 4A-4C include various portions of a flowchart that illustrates a method 400 of providing navigational assistance to a reserved parking space in accordance with one or more embodiments of the present technique. In some embodiments, method 400 may include receiving a request for navigational assistance to a destination, as depicted at block 402. Receiving a request for navigational assistance to a destination may include parking guidance server 102 receiving, from access device 106, a request for navigational assistance to destination 202. For example, user 114 may submit, via parking application 120, a request for navigational assistance from their current geographic location to a physical address corresponding destination 202. Upon user 114 submitting the request, access device 106 may submit a corresponding query for navigational assistance to parking guidance server 102. In some embodiments, a request for navigational assistance may be indicative of destination 202. For example, a request for navigational assistance may specify a start location (e.g., the current geographic location of user 114) and an end location (e.g., the location of destination 202).

In some embodiments, method 400 may include determining whether or not monitored parking is available at the destination, as depicted at block 404. Determining whether or not monitored parking is available at the destination may include determining whether or not a parking facility for which parking availability is monitored and/or corresponding parking availability information is available, is located at or near destination 202. For example, with regard to destination 202, determining whether or not a monitored parking is available may include parking guidance server 102 determining whether or not a parking facility for which parking availability is monitored (e.g., a parking facility for which corresponding parking availability information is available), is located within a given distance (e.g., one kilometer) of a geographic location of destination 202. In an exemplary embodiment, where parking facility 200 (e.g., having parking availability monitored by system 100) is within about one kilometer of destination 202, it may be determined that a monitored parking facility (e.g., parking facility 200) is located at or near destination 202.

In some embodiments, method 400 may include providing navigational assistance to the destination if it is determined that monitored parking is not available at the destination, as depicted at block 406. For example, where it is determined that a monitored parking facility is not located within a given distance (e.g., one kilometer) of a geographic location of destination 202, parking guidance system 102 may serve, to access device 106, content for providing navigational assistance to destination 202. In some embodiments, providing navigational assistance to a destination may include providing content for directing a user to the destination. For example, providing navigational assistance may include parking guidance system 102 serving, to access device 106, a navigational map including a route for directing user 114 form their current location to destination 202.

In some embodiments, method 400 may include, upon determining that monitored parking is available at the destination, prompting a user for a parking request, as depicted at block 408. Prompting a user for a parking request may include informing the user that parking is available at the destination and providing the user with an opportunity to request assistance with finding available parking at their destination. For example, in response to determining that monitored parking is available at destination 202, parking guidance server 102 may serve, for display via access device 106, a parking request page that informs user 114 that parking is available at destination 202 and provide user 114 with an opportunity to request assistance with finding available parking

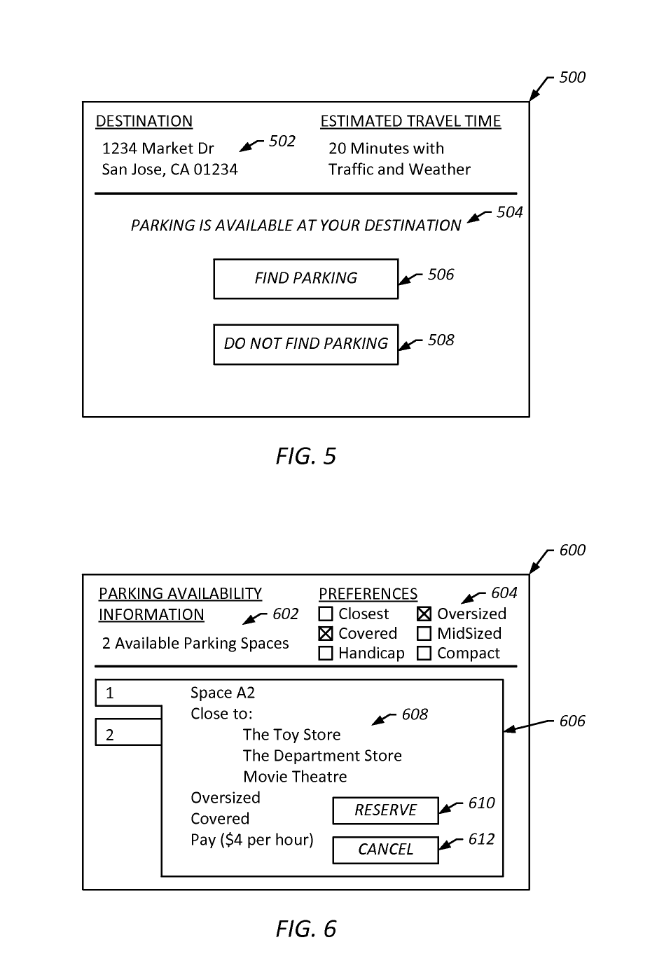

FIG. 5 a diagram that illustrates an exemplary parking request page 500 in accordance with one or more embodiments of the present technique. Parking request page 500 may be served by parking guidance server 102 and/or rendered for display via user access device 106. Parking request page 500 may include navigational information (e.g., destination, estimated travel time, and so forth) 502, an indication that parking is available at the destination 504, an option to find parking via selection of a “Find Parking” button 506 and an option to forgo finding parking (and continuing with navigation to destination 202) via selection of a “Do Not Find Parking” button 508.

In some embodiments, method 400 may include determining whether or not a parking request is received, as depicted at block 410. In some embodiments, it may be determined that a parking request is received where a user selects “Find Parking” button 506 of parking request page 500. For example, parking guidance server 102 may determine that a parking request is received in response to receiving, from access device 106, an indication that user 114 has selected the “Find Parking” button 506 of parking request page 500. In some embodiments, it may be determined that a parking request is not received where a user selects “Do Not Find Parking” button 508 of parking request page 500 and/or does not provide a response to the display of parking request page 500. For example, parking guidance server 102 may determine that a parking request is not received in response to receiving, from access device 106, an indication that user 114 has selected the “Do Not Find Parking” button 508 of parking request page 500 and/or receiving an indication that the option has timed-out based on a lack of response by user 114.

In some embodiments, method 400 may include, upon determining that a parking request is not received, providing navigational assistance to the destination, as depicted and discussed at block 406.

In some embodiments, method 400 may include, upon determining that a parking request is received, determining whether parking is available, as depicted and discussed at block 412. In some embodiments, determining whether parking is available may include determining whether or not the monitored parking facility includes one or more parking spaces that are available (e.g., unoccupied and/or unreserved). For example, in response to receiving an indication of user 114 selecting the “Find Parking” button 506, parking guidance server 102 may determine whether or not parking facility 200 includes one or more parking spaces 204 that are unoccupied and unreserved. In some embodiments, parking guidance server 102 may access and asses a local copy of parking status listing 300 and/or query parking management server 104 to determine whether or not parking facility 200 includes one or more parking spaces 204 that are unoccupied and unreserved. For example, parking guidance server 102 may assess of a current/updated version of parking status listing 300 similar to that of FIG. 3 and determine, based on the current/updated version of parking status listing 300, that at least parking spaces “A2” and “B3” of parking facility 200 are unoccupied and unreserved and, thus, may determine that parking is available. As a further example, if a current/updated version of a parking status listing were to indicate that all parking spaces were occupied and/or reserved, parking guidance server 102 may not identify any available parking spaces 204 of parking facility 200 that are unoccupied and unreserved and, thus, may determine that parking is not available.

In some embodiments, method 400 may include, in response to determining that parking is not available, providing navigational assistance to the destination, as depicted and discussed at block 406.

In some embodiments, method 400 may include, in response to determining that parking is available, providing an indication of available parking spaces, as depicted and discussed at block 414. Providing an indication of available parking spaces may include providing the user with a listing of one or more parking spaces that are available for reservation. For example, in response to determining that parking spaces “A2” and “B3” of parking facility 200 are unoccupied and unreserved, parking guidance server 102 may serve, for display via access device 106, a parking availability page to inform user 114 that parking spaces “A2” and “B3” at destination 202 are available for reservation.

FIG. 6 a diagram that illustrates an exemplary parking availability page 600 in accordance with one or more embodiments of the present technique. Parking availability page 600 may be served by parking guidance server 102 and/or rendered for display via user access device 106. Parking availability page 600 may include parking availability summary 602, parking preferences 604, and/or parking space information windows 606 corresponding to available parking spaces.

Parking preferences 604 may include any number of different types of preferences. For example, preferences may include “No Parallel Parking”, and so forth. In some embodiments, parking preferences 604 may be user selectable. For example, user 114 may select or de-select preferences 604. In some embodiments, preferences may be pre-populated. For example, preferences “covered” and “oversized” may be selected automatically based on user 114 previously selecting the preferences in the previous query for parking space information and/or the preferences being identified as default preferences.

In some embodiments, parking availability summary 602 may include information summarizing the number of available parking spaces that satisfy selected preferences 604. For example, it may be determined that two parking spaces (e.g., parking spaces “A2” and “B3” of parking facility 200) are available, oversized and covered. In some embodiments, a parking space information window may include information (e.g., an identifier, a location, a size, a fee, or the like) associated with the corresponding parking space. For example, a parking space information window 606 corresponding to parking space “A2” may indicate that parking space “A2” is close to “The Toy Store”, “The Department Store” and the “Movie Theatre”, is oversized, covered, and has a rate of $4 per hour. In some embodiments, a parking space information window 606 corresponding to another parking space may be displayed in response to a user simply selecting a different tab. For example, a parking space information window 606 corresponding to parking space “B3” may be displayed upon user 114 selecting tab “2”.

In some embodiments, the user may be afforded an opportunity to reserve one of the available parking spaces. For example, a user may select a “Reserve” button 610 of parking space information window corresponding to space “A2” to reserve parking space “A2”.

In some embodiments, method 400 may include determining whether or not a reservation request is received, as depicted at block 416. In some embodiments, it may be determined that a parking reservation request is received where a user selects a “Reserve” button 610 of a given parking space information window 606. For example, parking guidance server 102 may determine that a parking reservation request for parking space “A2” is received in response to receiving, from access device 106, an indication that user 114 has selected the “Reserve” button 506 of parking space information window 606 corresponding to parking space “A2”.

It may be determined that a parking reservation request is not received where a user selects the “Cancel” button 612 of parking space information window(s) 606 and/or does not provide a response. For example, parking guidance server 102 may determine that a parking reservation request is not received in response to receiving, from access device 106, an indication that user 114 has selected the “Cancel” button 612 of parking space information window 606 and/or receiving an indication that the option to reserve a parking space has timed-out based on a lack of response by user 114.

In some embodiments, method 400 may include, in response to determining that a parking reservation request is not received, providing navigational assistance to the destination, as depicted and discussed at block 406.

In some embodiments, method 400 may include, in response to determining that a parking reservation request is received, processing the parking reservation request, as depicted and discussed at block 418. In some embodiments, processing the parking reservation request may include updating parking status listing(s) 300 to reflect the change in parking status due to the parking reservation request. For example, parking status listing(s) 300 stored at datastore 132 and/or 142 may be updated to reflect the change in status due to the parking reservation request. In an exemplary embodiment, where parking status listing 300 is similar to that depicted in FIG. 3, upon receiving a parking reservation request for parking space “A2”, a reservation status 308 for the entry 302 corresponding to parking space “A2” may be changed from “U” to “R”, to indicate that parking space “A2” is currently reserved.

Method 400 may include providing navigational assistance to the reserved parking space, as depicted at block 420 (See FIG. 4B). In some embodiments, providing navigational assistance to the reserved parking space may include providing instructions/directions for directing a user to the reserved parking space. For example, providing navigational assistance may include parking guidance server 102 serving, to access device 106, a navigational map including a route for directing user 114 form their current location to the reserved parking space “A2”.

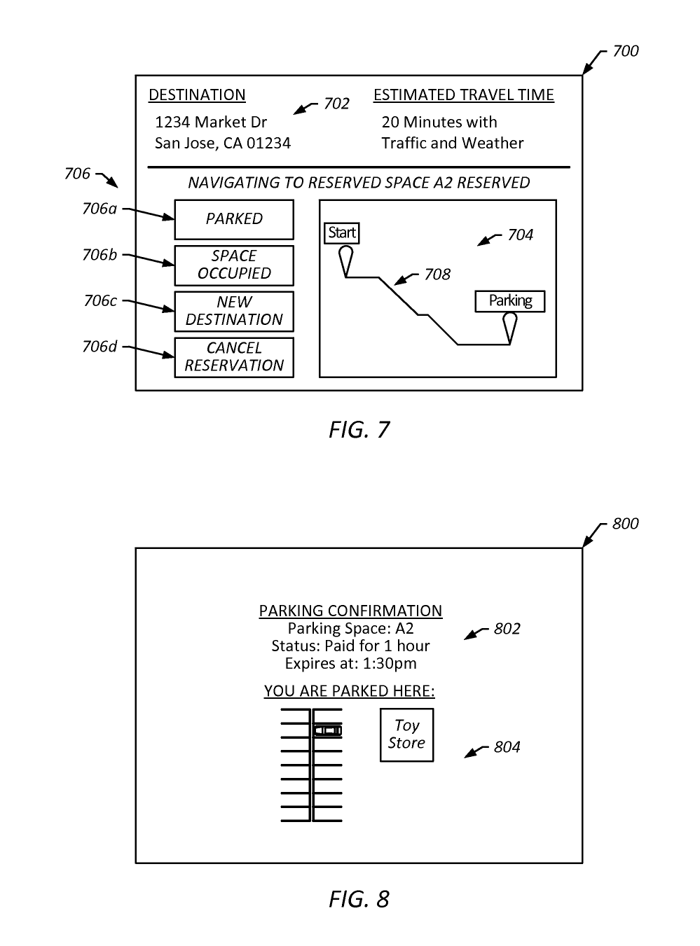

FIG. 7 a diagram that illustrates an exemplary navigational page 700 in accordance with one or more embodiments of the present technique. Navigational page 700 may be served by parking guidance server 102 and/or rendered for display via user access device 106. Navigational page 700 may include navigational information 702, a navigational map 704, and one or more user selectable navigation options 706. Navigational map 704 may include a geographic map of a region and including a route 708 for directing user 114 form their current location (e.g., “Start”) to reserved parking space “A2” (e.g., “Parking”).

In some embodiments, user selectable navigation options 706 may include a “Parked” button 706a, a “Space Occupied” button 706b, a “New Destination” button 706c, and a “Cancel Reservation” button 706d.

In some embodiments, a user may select a “Parked” button 706a to provide an indication that their vehicle is parked within a parking space. For example, upon parking their vehicle in parking space “A2”, user 114 may select the “Parked” button 706a to provide an indication that their vehicle is parked in reserved parking space “A2”.

In some embodiments, a user may select a “Space Occupied” button 706b to provide an indication that a vehicle is already parked in a reserved space. For example, upon arriving at parking space “A2” and determining that a vehicle is already parked in parking space “A2”, user 114 may select the “Space Occupied” button 706b to provide an indication that another vehicle is already parked in reserved parking space “A2”. In some embodiments, a parking status listing may be updated to reflect the indication that another vehicle is parked in reserved parking space “A2”. For example, upon user 114 selecting “Space Occupied” button 706b, parking status listing(s) 300 stored at datastore 132 and/or 142 may be updated to reflect the indication that another vehicle is parked in reserved parking space “A2”. In an exemplary embodiment, where parking status listing 300 is similar to that depicted in FIG. 3, a parking status 306 for the entry 302 corresponding to parking space “A2” may be changed from “U” to “O”, indicating that parking space “A2” is currently occupied.

In some embodiments, a user may select a “New Destination” button 706c to cancel the reservation and request navigational assistance to a different destination. For example, while traveling to parking space “A2”, user 114 may decide to visit another store at a different location, and may select the “New Destination” button 706c. Upon selecting “New Destination”, user 114 may be redirected to an interface that provides user 114 an option to specify a new destination that is different from the currently specified destination.

In some embodiments, a user may select the “Cancel Reservation” button 706d to cancel the reservation. In some embodiments, upon selection of the “Cancel Reservation” button 706d the reservation for the reserved parking space may be released.

In some embodiments, method 400 may include determining whether a reserved space has been occupied, as depicted at block 422. In some embodiments, determining whether a reserved space has been occupied may include accessing a parking status listing to determine whether or not a parking status of the reserved parking space is listed as unoccupied or occupied. For example, determining whether reserved space “A2” has been occupied may include, parking guidance server 102 accessing parking status listing 300 to assess a parking status 306 corresponding to parking space “A2”. In some embodiments, a reserved parking space may be determined to be unoccupied where a corresponding parking status is indicative of the reserved parking space being unoccupied. For example, reserved parking space “A2” may be determined to be unoccupied where a corresponding parking status 306 of parking status listing 300 includes a “U” indicative of the reserved parking space “A2” being unoccupied. In some embodiments, a reserved parking space may be determined to be occupied where a corresponding parking status is indicative of the reserved parking space being occupied. For example, reserved parking space “A2” may be determined to be occupied where a corresponding parking status 306 of parking status listing 300 includes a “O” indicative of the reserved parking space “A2” being occupied.

In some embodiments, method 400 may include, in response to determining that a parking space reserved by the user is now occupied, attempting to identify one or more other parking spaces available for reservation, allowing a user to reserve one of the other parking space, and/or providing navigational assistance to the other parking space reserved. For example, method 400 may include, upon determining that a parking space previously reserved by the user is now occupied, retuning to block 412 of method 400.

In some embodiments, method 400 may include determining whether a user has requested to navigate to a new destination, as depicted at block 424. In some embodiments, determining whether a user has requested to navigate to a new destination may include determining whether or not a user has selected “New Destination” button 706c and/or has otherwise specified a new destination that is different from the current destination. For example, parking guidance server 102 may determine that user 114 has requested navigate to a new destination upon receiving, from access device 106, an indication that user 114 has selected the “New Destination” button 706c and/or has otherwise specified an address/location that different from the address/location of destination 202.

In some embodiments, method 400 may include, in response to determining that a user has requested to navigate to a new destination, cancelling the current reservation, as depicted at block 426, and/or returning to block 404 to initiate providing navigational assistance to the new destination. In some embodiments, cancelling the parking reservation may include updating parking status listing(s) 300 to reflect the change in parking status due to the release of the reservation. For example, where parking space “A2” is reserved by user 114, upon receiving, from access device 106, an indication that user 114 has requested to navigate to a new destination, a reservation status 308 of parking status listing 300 corresponding to parking space “A2” may be changed from “R” to “U”, indicating that parking space “A2” is currently unreserved, thereby releasing the reservation of parking space “A2” by user 114.

In some embodiments, method 400 may include determining whether a user has requested to cancel the parking reservation, as depicted at block 428. In some embodiments, determining whether a user has requested to cancel the parking reservation may include determining whether or not a user has selected “Cancel Reservation” button 706d and/or has otherwise indicated their desire to cancel the parking reservation. For example, parking guidance server 102 may determine that user 114 has requested to cancel the parking reservation for parking space “A2” upon receiving, from access device 106, an indication that user 114 has selected the “Cancel Reservation” button 706d.

In some embodiments, method 400 may include, in response to determining that the user has requested to cancel the parking reservation, cancelling the current reservation, as depicted at block 430. In some embodiments, cancelling the parking reservation may include updating parking status listing(s) 300 to reflect the change in parking status due to the release of the reservation. For example, where parking space “A2” is reserved by user 114, upon receiving, from access device 106, an indication that user 114 requests to cancel the parking reservation, a reservation status 308 of parking status listing 300 corresponding to parking space “A2” may be changed from “R” to “U”, indicating that parking space “A2” is currently unreserved. In some embodiment, navigational assistance to the parking facility including the previously reserved parking space may still be provided. For example, upon cancelling the current reservation for parking space “A2”, navigational assistance may continue to be provided to parking facility 200 and/or destination 202 as discussed with regard to at least block 406.

In some embodiments, method 400 may include determining whether the user's vehicle has been parked, as depicted at block 432. In some embodiments, it may be determined that a user's vehicle has been parked in response to receiving a corresponding indication. For example, parking guidance server 102 may determine the vehicle of user 114 has been parked in response to receiving, from access device 106, an indication that user 114 has selected the “Parked” button 706a.

In some embodiments, an indication that a user's vehicle is parked may include location information indicative of the location at which the user's vehicle has been parked. For example, access device 106 may determine its location at or near the time of user 114 selecting the “Parked” button 706a and may provide an indication of the location to parking guidance server 102. In some embodiments, access device 106 may acquire its location via any suitable positioning technique. For example access device 106 may acquire geographic coordinates corresponding to its location via an integrated via a global positioning system (GPS) device, via assessing its location relative to nearby network access points (e.g., cell phone towers and/or Wi-Fi access points) or the like.

In some embodiments, location information may be provided via a location transmitter associated with a parking space. For example, upon a user parking in parking space “A2” a location transmitter located adjacent parking space “A2” may transmit a wireless signal to access device 106 providing an indication that the user's vehicle is curtly parked in parking space “A2”. In some, embodiments, access device 106 may forward corresponding location information to parking guidance server 102. For example, access device 106 may forward, to parking guidance server 102, parking location update indicative of the user's vehicle being parked in parking space “A2”.

Any location data/information is used in a way that respects user privacy. For example, a user's location may not be obtained or tracked unless the user has provided permission after being informed as to how the user's location data is to be used. Furthermore, location data that is collected can be stored and handled in a way that ensures user privacy. For example, location data/information may be discarded after it is used to identify whether a user's vehicle is parked in a reserved space.

Method 400 may include identifying a parking space in which the user's vehicle is parked, as depicted at block 438. In some embodiments, a parking space in which the user's vehicle is parked may be identified based on location information received from access device 106. For example, where access device 106 provides, to parking guidance server 102, location information including geographic coordinates that correspond to a location of access device 106 and/or the vehicle at or near the time of user 114 selecting the “Parked” button 706a, parking guidance system 102 may identify a parking space 204 that corresponds to the geographic coordinates. In an exemplary embodiment, where the geographic coordinates correspond to a location of parking space “A2”, parking space “A2” may be identified as a location where the user's vehicle is parked. As a further example, where access device 106 provides, to parking guidance server 102, location information indicative of the user's vehicle being parked in a particular parking space (e.g., parking space “A2”), parking guidance system 102 may identify the particular parking space (e.g., parking space “A2”) as the parking space in which the user's vehicle is parked.

Method 400 may include determining whether or not the user's vehicle is parked in the reserved parking space, as depicted at block 440 (See FIG. 4C). In some embodiments, determining whether or not the user's vehicle is parked in the reserved parking space may include comparing the parking space in which the user's vehicle is parked (as identified at block 438) to the reserved parking space (e.g., the parking space reserved at block 416). In some embodiments, it may be determined that the user's vehicle is parked in the reserved parking space where the parking space in which the user's vehicle is parked matches or otherwise correspond to the reserved parking space. For example, it may be determined that the user's vehicle is parked in the reserved parking space where the user has reserved parking space “A2” and it is determined that the user's vehicle is parked in parking space “A2”. In some embodiments, it may be determined that the user's vehicle is not parked in the reserved parking space where the parking space in which the user's vehicle is parked does not match or otherwise correspond to the reserved parking space. For example, it may be determined that the user's vehicle is not parked in the reserved parking space where the user has reserved parking space “A2” and it is determined that the user's vehicle is parked in parking space “A6”.

In some embodiments, method 400 may include, in response to determining that the user's vehicle is parked in the reserved parking space, determining whether or not the parking space in which the user's vehicle is parked is a paid parking space (e.g., requires payment of a fee for the right to park in the parking space), as depicted at block 442. For example, where the user's vehicle is parked in parking space “A2”, parking guidance server 102 may determine whether or not parking space “A2” is a paid parking space.

In some embodiments, method 400 may include, in response to determining that the parking space in which the user's vehicle is parked is not a paid parking space, updating a parking space status, as depicted at block 444. Updating a parking space status may include updating a parking status listing to reflect the user's vehicle being parked in the parking space. For example, where the user's vehicle is parked in parking space “A2”, a parking status 306 of parking status listing 300 corresponding to parking space “A2” may be changed from “U” to “O”, indicating that parking space “A2” is currently occupied. In some embodiments, a reservation status 308 of parking status listing 300 corresponding to parking space “A2” may be changed from “U” to “R” in response to parking monitor 108 providing a corresponding parking status update indicative of parking space “A2” being occupied.

Method 400 may include providing a parking confirmation, as depicted at block 446. Providing a parking confirmation may include parking guidance server 102 serving, for display via access device 106, a parking confirmation page. FIG. 8 is a diagram that illustrates an exemplary parking confirmation page 800 in accordance with one or more embodiments of the present technique. Parking confirmation page 800 may be served by parking guidance server 102 and/or rendered for display via user access device 106. Parking confirmation page 800 may include parking information (e.g., parking location, parking status, a parking expiration time, and so forth) 802 and/or a parking map 804. Parking map 804 may provide a graphical illustration of where the user's vehicle is parked relative to other geographic points of interest (e.g., other parking spaces, the destination, and so forth).

In some embodiments, method 400 may include, in response to determining that the parking space in which the user's vehicle is parked is a paid parking space, requesting payment for the parking space, as depicted at block 448. Requesting payment for the parking space may include informing the user of the parking fee and providing the user with an option to initiate payment. For example, parking guidance server 102 may serve, for display via access device 106, a payment request page that informs user 114 of a parking fee associated with the parking space in which their vehicle is parked and/or an option to initiate payment of the parking fee.

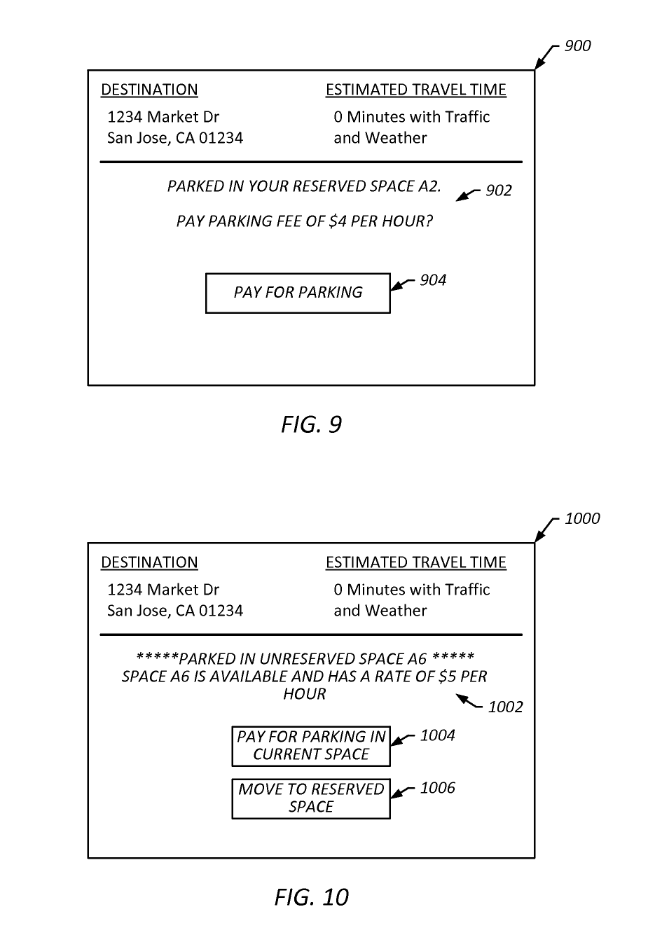

FIG. 9 a diagram that illustrates an exemplary payment request page 900 in accordance with one or more embodiments of the present technique. Payment request page 900 may be served by parking guidance server 102 and/or rendered for display via user access device 106. Payment request page 900 may include payment information (e.g., a fee associated with the parking space) 902 and an option to initiate payment of the parking fee via selection of a “Pay For Parking” button 904. Upon selection of “Pay For Parking” button 904, a fee may be submitted on behalf of the user. For example, access device 106 may be associated with a payment account such that payment is automatically provided upon user selection of “Pay For Parking” button 904. In some embodiments, upon selection of “Pay For Parking” button 904, user 114 may be prompted to provide payment/account information, and payment may be provided based on the provided information. In some embodiments, a user may be provide an option to provide an electronic payment (e.g., via payment service 110) and/or cash (e.g., via a payment facility located at the parking facility).

In some embodiments, method 400 may include, in response to determining that a payment has been received, updating a parking space status, as depicted at block 450. In some embodiments, method 400 may include, in response to determining that a payment has not been received, proceeding to cancelling the reservation, as discussed with regard to block 430. For example, the reservation for parking space “A2” may be cancelled where user 114 fails to submit a payment via payment request page 900.

Returning to block 440, in some embodiments, method 400 may include, in response to determining that the user's vehicle is parked in the reserved parking space, determining whether or not the parking space in which the user's vehicle is parked is an available parking space, as depicted at block 452. In some embodiments, it may be determined that a parking space is not available where the parking space is already reserved or otherwise unavailable for parking of the user's vehicle. For example, upon parking guidance server 102 determining that the user's vehicle is parked in parking space “A6” (despite the user having reserved parking space “A2”), parking guidance server 102 may determine that parking space “A6” is not available based on parking status listing 300 indicating that parking space “A6” is already reserved (See FIG. 3). In some embodiments, it may be determined that a parking space is available where the parking space is not already reserved or is otherwise available for parking of the user's vehicle. For example, upon parking guidance server 102 determining that the user's vehicle is parked in parking space “B3” (despite the user having reserved parking space “A2”), parking guidance server 102 may determine that parking space “B3” is available based on parking status listing 300 indicating that parking space “B3” is unreserved (See FIG. 3).

In some embodiments, method 400 may include, in response to determining that the parking space is available, providing an option to remain parked in the parking space, as depicted at block 454. For example, in response to determining that the user's vehicle is parked in an available parking space, parking guidance server 102 may serve, for display via access device 106, a parking options page that informs user 114 of the option to move their vehicle to the parking space they have reserved or to allow their vehicle to remain in the parking space in which it is currently parked.

FIG. 10 is a diagram that illustrates an exemplary parking options page 1000 in accordance with one or more embodiments of the present technique. Parking options page 1000 may be served by parking guidance server 102 and/or rendered for display via user access device 106. Parking options page 1000 may include parking information 1002, an option for the vehicle to remain in the available parking space in which they are currently parked (e.g., parking space “A6”) via selection of a “Pay For Parking in Current Space” button 1004, and an option to indicate their intention to move their vehicle to the reserved parking space (e.g., parking space “A2”) via selection of a “Move to Reserved Space” button 1006.

Method 400 may include determining whether the user intends for their vehicle to remain in the available parking space in which it is currently parked or intends to move their vehicle to the reserved parking space, as depicted at block 456. In some embodiments, it may be determined that the user is intends for their vehicle to remain in the available parking space in which it is currently parked in response to receiving a corresponding indication. For example, parking guidance server 102 may determine that a user intends for their vehicle to remain in the available parking space in which it is currently parked in response to receiving, from access device 106, an indication that user 114 has selected the “Pay For Parking in Current Space” button 1004. In some embodiments, method 400 may include, upon determining that the user intends for their vehicle to remain in the available parking space in which it is currently parked, determining whether or not the parking space in which the user's vehicle is currently parked (e.g., parking space “A6”) is a paid parking space, as discussed with regard to block 442.

In some embodiments, it may be determined that the user intends to move their vehicle to the reserved parking space in response to receiving a corresponding indication. For example, parking guidance server 102 may determine that the user intends to move their vehicle to the reserved parking space in response to receiving, from access device 106, an indication that user 114 has selected the “Move to Reserved Space” button 1006. In some embodiments, method 400 may include, in response to determining that the user intends to move their vehicle to the reserved parking space, providing navigational assistance to the reserved parking space (e.g., parking space “A2”), as depicted at block 420, if it is determined that a user intends for their vehicle to be moved to the reserved parking space.

Returning to block 452, in some embodiments, method 400 may include, in response to determining that the parking space is not available, prompting a user to move their vehicle, as depicted at block 458. Prompting a user to move their vehicle may include informing the user that the parking space in which the user's vehicle is currently parked is not available (e.g., already reserved by another user) and/or suggesting that the user move their vehicle to another parking space (e.g., move their vehicle to the parking space they have reserved). For example, in response to determining that that the parking space in which the user's vehicle is parked (e.g., parking space “A6”) is not an available parking space, parking guidance server 102 may serve, for display via access device 106, a move request page that informs user 114 that parking is not available in the current parking space and/or request that user 114 move their vehicle to the reserved parking space (e.g., parking space “A2”).

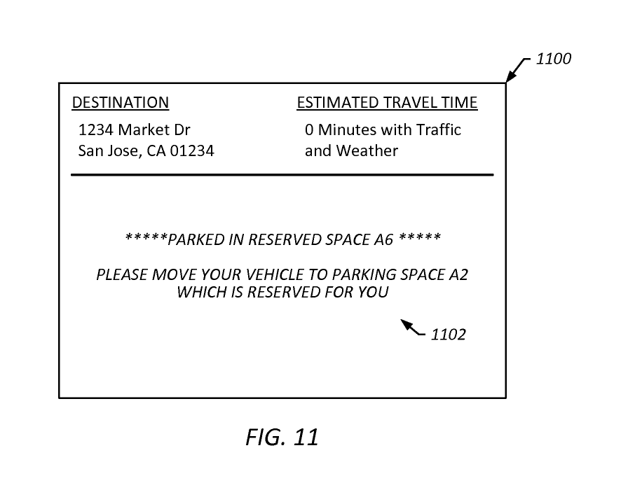

FIG. 11 is a diagram that illustrates an exemplary move request page 1100 in accordance with one or more embodiments of the present technique. Move request page 1100 may be served by parking guidance server 102 and/or rendered for display via user access device 106. Move request page 1100 may include alert content 1102 alerting the user to the fact that parking space “A6” is reserved and/or requesting that the user move their vehicle to the reserved parking space “A2”. For example, in the illustrated embodiment, alert content 1102 states: “*****Parked in Reserved Space A6*****” and “Please Move Your Vehicle to Parking Space A2 Which Is Reserved for You”. In some embodiments, method 400 may also include providing navigational assistance to the reserved parking space (e.g., parking space “A2”), as depicted at block 420. For example, a navigational page similar to that of page 700 of FIG. 7 may be displayed after move request page 1100 has been displayed for a given period of time (e.g., thirty seconds), upon detecting the user's vehicle is moving from the unavailable parking space (e.g., moved from parking space “A6”) or the like, such that user 114 is informed that the parking space is already reserved and is provided navigational assistance to the reserved parking space.

In some embodiments, parking system 100 may provide an alert to a user prior to their parking reservation expiring. For example, where a user 114 parks their vehicle in parking space “A2” at about 12:30 pm and pays a fee in exchange for the right for their vehicle to remain parked in parking space “A2” until 1:30 pm, parking guidance server 102 may provide a parking expiration alert at or near a parking expiration time of 1:30 pm. In some embodiments, the parking expiration alert may be provided via a mobile communications device such that a user is informed of the upcoming parking expiration time. In some embodiments, the parking expiration alert may be accompanied by an option to pay an additional parking fee to extend the parking expiration time such that a user may extend their parking expiration via the mobile communications device without having to return to the parking facility.

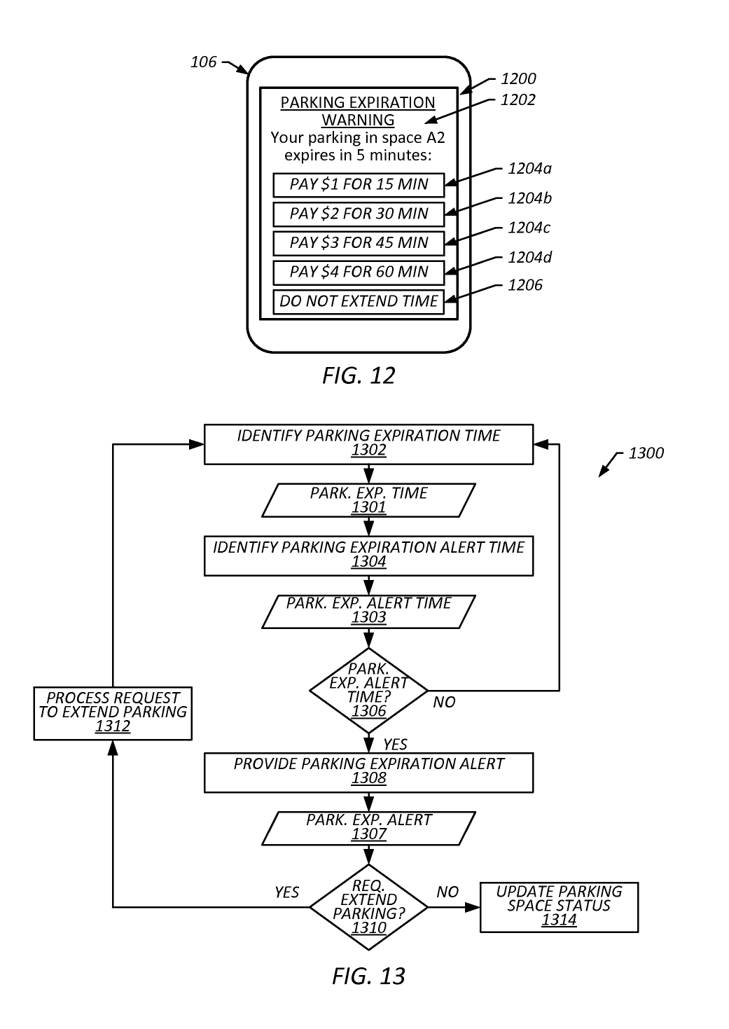

FIG. 12 is a diagram that illustrates an exemplary parking expiration alert page 1200 in accordance with one or more embodiments. Parking expiration alert page 1200 may be served by parking guidance server 102 and/or rendered for display via user access device 106. Parking expiration alert page 1200 may include expiration information (e.g., “Your parking in space A2 expires in 5 minutes”) 1202, an option to initiate payment for an extension of a parking reservation (e.g., via selection of payment buttons 1204a-1204d (collectively referred to herein as payment buttons 1204)), and an option to refrain from extending the reservation (e.g., via selection of “Do Not Extend Time” button 1206). Upon user selection of one of payment buttons 1204, a corresponding payment may be submitted on behalf of the user. For example, access device 106 may be associated with a payment account such that a $1 payment is automatically provided upon user selection of “Pay $1 for 15 min” button 1204a. In some embodiments, upon selection of a payment button 1204, user 114 may be prompted to provide payment/account information. A payment may be provided based on the provided payment/account information. In some embodiments, a user may be provide an option to provide an electronic payment (e.g., via credit card or an online payment system (e.g., via payment service 110) and/or cash (e.g., via a payment facility located at the parking facility).

FIG. 13 is a flowchart that illustrates a method 1300 of providing parking expiration alerts in accordance with one or more embodiments of the present technique. Method 1300 may include identifying a parking expiration time 1301, as depicted at block 1302. In some embodiments, a parking expiration time may include a time at which authorization for a vehicle to be parked in a given parking space is set to expire. For example, where a user 114 parks their vehicle in parking space “A2” at 12:30 pm and submits a payment of $4, entitling their vehicle to be parked in parking space “A2” for one hour, parking guidance server 102 may determine a corresponding parking expiration time of 1:30 pm. As a further example, where a user 114 parks their vehicle in parking space “A2” at 12:30 pm and submits a payment of $4, entitling their vehicle to be parked in parking space “A2” for one hour, and user 114 subsequently submits an additional payment of $1, extending the time their vehicle is entitled to be parked in paring space “A2” by an additional fifteen minutes, parking guidance server 102 may determine a corresponding parking expiration time of 1:45 pm.

Method 1300 may include identifying a parking expiration alert time 1303, as depicted at block 1304. In some embodiments, a parking expiration alert time may include a time at which a corresponding parking expiration alert is to be provided to a user. For example, upon the current time meeting or exceeding the parking expiration alert time, a corresponding parking alert may be provided for presentation to user such that the user is informed of the expiration (or potential expiration of) the time for which their vehicle is entitled to be parked in the parking space.

In some embodiments, parking expiration alert time 1303 may be the same as parking expiration time 1301 such that the parking expiration alert is provided at or near the parking expiration time 1301. For example, both parking expiration time 1301 and parking expiration alert time 1303 may be 1:30 pm such that, if the parking reservation is not extended or the user does not provide an indication that their vehicle has been moved prior to 1:30 pm, a parking expiration alert may be provided at or near 1:30 pm.

In some embodiments, parking expiration alert time 1303 may be offset from parking expiration time 1301 such that a parking expiration alert is provided at some point in time prior to parking expiration time 1301. Such an offset parking expiration alert time may provide a user with the opportunity to extend their parking, time, move their vehicle, or otherwise resolve any issues prior to the parking expiration time. For example, where parking expiration time 1301 is 1:30 pm, and an alert offset of five minutes is specified, parking expiration alert time 1303 may be 1:25 pm. Accordingly, if the parking reservation is not extended or the user does not provide an indication that their vehicle has been moved prior to 1:25 pm, a parking expiration alert may be provided at or near 1:25 pm.

Method 1300 may include determining whether the parking expiration alert time 1303 has occurred, as depicted at block 1306. In some embodiments, determining whether the parking expiration alert time has occurred may include determining whether or not the current time is equal to or greater than parking expiration alert time 1303. In some embodiments, method 1300 may include, in response to determining that parking expiration alert time has not yet occurred, determining whether parking expiration time 1301 and/or the parking expiration alert time 1303 have changed (e.g., a user has extended their reservation) and/or continuing to monitor for the occurrence of parking expiration alert time 1303.

Method 1300 may include, in response to determining that the parking expiration alert time 1303 has occurred, providing a parking expiration alert 1307, as depicted at block 1308. For example, where parking expiration alert time 1303 is identified as 1:35 pm and the current time is 1:35 pm (or later), parking guidance server 102 may serve, to access device 106, parking expiration alert page 1200 and/or access device 106 may render parking expiration alert page 1200 for display to user 114.

Method 1300 may include determining whether or not a request to extend parking has been received, as depicted at block 1310. In some embodiments, it may be determined that a request to extend parking has been received where one of payment buttons 1204 is selected. For example, parking guidance server 102 may determine that a request to extend parking has been received upon receiving, from access device 106, an indication that user 114 has selected payment button 1204a. Method 1300 may include processing the request to extend parking, as depicted at block 1312. In some embodiments processing the request may include collecting or otherwise securing a payment to extend the parking reservation. For example, upon receiving an indication that user 114 has selected payment button 1204a, parking guidance server 102 may query payment service 110 to fund, collect or otherwise secure the $1 payment required for extending parking expiration time 1301 by an additional fifteen minutes.

In some embodiments, it may be determined that a request to extend parking has been not received where the “Do Not Extend Time” button 1206 is selected. For example, parking guidance server 102 may determine that a request to extend parking has not been received upon receiving, from access device 105, an indication that user 114 has selected the “Do Not Extend Time” button 1206.

Method 1300 may include, upon determining that a request to extend parking has not been received, updating a parking space status, as depicted at block 1314. In some embodiments, updating a parking space status may include updating a parking status listing to reflect the user's reservation having expired. For example, where the a user's reservation for parking in parking space “A2” is not extended, a reservation status 308 of parking status listing 300 corresponding to parking space “A2” may be changed from “R” to “U”, indicating that parking space “A2” is currently unreserved. In some embodiments, a parking status 306 of parking status listing 300 corresponding to parking space “A2” may be changed from “O” to “U” in response to parking monitor 108 providing a corresponding parking status update indicative of parking space “A2” being unoccupied.

In some embodiments, parking system 100 may provide navigational assistance for returning to a parking space. For example, where user 114 parks their vehicle in parking space “A2” and visits a shopping mall nearby, user 114 may request navigational assistance for returning from the shopping mall to parking space “A2”. In some embodiments, navigational assistance may be provided via a navigational map provided for display to the user via a mobile communications device. In some embodiments, a navigational map may include a graphical depiction of a route from the user's current location to the parking space such that a user can easily find their vehicle.

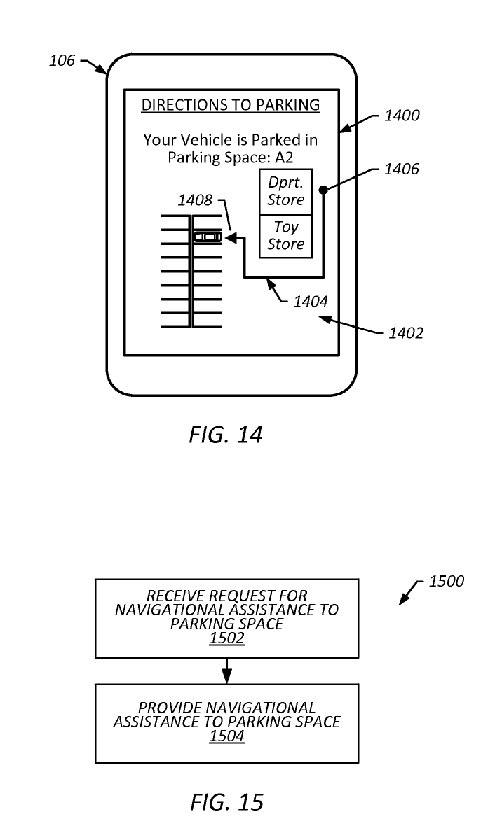

FIG. 14 is a diagram that illustrates an exemplary parking return page 1400 in accordance with one or more embodiments. Parking return page 1400 may be served by parking guidance server 102 and/or rendered for display via user access device 106. Parking return page 1400 may include a navigational map 1402 including a route 1404 for directing a user from a start location 1406 to an end location 1408. In some embodiments, start location 1406 may include a user's current location. For example, start location 1406 may include the location of user 114 at or near the time of requesting navigational assistance for returning to a parking space where their vehicle is parked. In some embodiments, end location 1408 may include the location of the parking space in which the user's vehicle is parked. For example, where user 114 has parked their vehicle in parking space “A2” end location 1408 may include the location of parking space “A2”. In some embodiments, end location 1408 may correspond to a parking space currently reserved by the user, as discussed above.

FIG. 15 is a flowchart that illustrates a method 1500 of providing navigational assistance to a parking space in accordance with one or more embodiments of the present technique. Method 1300 may include receiving a request for navigational assistance to a parking space, as depicted at block 1502. In some embodiments, receiving a request for navigational assistance to a parking space may include receiving a request for navigational assistance from a user via their mobile communications device. For example, parking guidance server 102 may receive, from access device 106, a query for navigational assistance to a parking space in which the user's vehicle is parked. In some embodiments, the query may be generated in response to user 114 submitting a corresponding request via access device 106.

Method 1500 may include providing navigational assistance to the parking space, as depicted at block 1504. In some embodiments, providing navigational assistance to the parking space may include identifying a parking space in which the user's vehicle is parked and providing content for providing navigational assistance to the parking space in which the user's vehicle is parked. For example, parking guidance server 102 may query a parking status listing to determine that parking space “A2” is currently reserved by user 114, and may serve, to access device 106, parking return page 1400. User access device 106 may render parking return page 1400 for display to user 114. Accordingly, user 114 may use map 1402 and route 1404 for navigating from their current location to the parking space in which their vehicle is parked (e.g., parking space “A2”).

Methods 400, 1300 and 1500 are exemplary embodiments of methods employed in accordance with techniques described herein. Methods 400, 1300 and 1500 may be may be modified to facilitate variations of its implementations and uses. Methods 400, 1300 and 1500 may be implemented in software, hardware, or a combination thereof. Some or all of methods 400, 1300 and 1500 may be implemented by parking application 120, parking guidance module 130, parking management module 140 and/or monitor module 150. The order of methods 400, 1300 and 1500 may be changed, and various elements may be added, reordered, combined, omitted, modified, etc.

Although certain embodiments are described herein with regard to use of traditional vehicles, such as those actually driven by persons, similar techniques may be employed with the use of technologically advanced vehicles, such as self-driving vehicles (e.g., car that are capable of driving/parking themselves with little or no human interaction and/or when no human is present in the vehicle). In some embodiments, a self-driving vehicle may be capable of parking itself in a reserved spot. For example, a self-driving vehicle may secure a parking location based on a user selected destination as described above, the self-driving vehicle may deliver the user to an entrance of the destination, the self-driving vehicle may, then, proceed to navigate to and park within a reserved parking space in a manner similar to that described with regard to at least FIGS. 4A-4C. Thus, for example, if a reserved parking space is occupied, the self-driving vehicle may query a parking system to identify an unoccupied/unreserved parking space, may effectuate a reservation the parking space and may automatically navigate to the unoccupied/unreserved parking space in a manner similar to that described with regard to at least FIGS. 4A-4C. In some embodiments, a self-parking vehicle may select a reserved parking space based on user preferences that are known or otherwise determined (e.g., based on historical user parking patterns) as discussed above. Accordingly, in some embodiments, a self-driving vehicle may automatically park itself via interactions with entities of system 100 in a manner similar to that of at least method 400 described herein with regard to human users.

Moreover, in some embodiments, upon being summoned by a user, a self-driving vehicle may automatically navigate to a location where the self-driving vehicle dropped-off a user (e.g., the entrance of the destination) or another location suitable for picking-up the user. For example, upon a user finishing a shopping trip, the user may employ their mobile access device to summon their self-driving vehicle to pick them up, and the self-driving vehicle may respond to the summons by navigating from the space where it is parked to the entrance of the shopping mall where the user was dropped off and/or the current location of the mobile access device (presumably indicative of the current location of the user).

In some embodiments, a user may be provided a mapping to their self-driving vehicle. For example, upon finishing a shopping trip, the user may query for directions to the parking location self-driving vehicle (the location of which they may not know due to the vehicle parking itself) and may be provided a map to the location of their self-driving vehicle (e.g., where the self-driving vehicle automatically parked itself) in a manner similar to that described with regard to at least method 1500 and FIGS. 14 and 15. Accordingly, in some embodiments, a self-driving vehicle may navigate to pick-up a user and/or a user may be provided a mapping to assist them in navigating to a location where their self-parking vehicle has parked.

Exemplary Computer System

FIG. 16 is a diagram that illustrates an exemplary computer system 2000 in accordance with one or more embodiments of the present technique. Various portions of systems and methods described herein, may include or be executed on one or more computer systems similar to system 2000. For example, paring guidance server 102, parking management server 104, access device 106, parking monitor 108, and/or parking management server 110 may each include a configuration similar to at least a portion of computer system 2000. Further, methods/processes/modules described herein (e.g., parking application 120, parking guidance module 130, parking management module 140 and/or monitor module 150) may be executed by one or more processing systems similar to that of computer system 2000.

Computer system 2000 may include one or more processors (e.g., processors 2010a-2010n) coupled to system memory 2020, an input/output I/O device interface 2030 and a network interface 2040 via an input/output (I/O) interface 2050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 2000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 2020). Computer system 2000 may be a uni-processor system including one processor (e.g., processor 2010a), or a multi-processor system including any number of suitable processors (e.g., 2010a-2010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 2000 may include a computer system employing a plurality of computer systems (e.g., distributed computer systems) to implement various processing functions.

I/O device interface 2030 may provide an interface for connection of one or more I/O devices 2060 to computer system 2000. I/O devices may include any device that provides for receiving input (e.g., from a user) and/or providing output (e.g., to a user). I/O devices 2060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 2060 may be connected to computer system 2000 through a wired or wireless connection. I/O devices 2060 may be connected to computer system 2000 from a remote location. I/O devices 2060 located on remote computer system, for example, may be connected to computer system 2000 via a network and network interface 2040.

Network interface 2040 may include a network adapter that provides for connection of computer system 2000 to a network. Network interface may 2040 may facilitate data exchange between computer system 2000 and other devices connected to the network. Network interface 2040 may support wired or wireless communication. The network may include an electronic communication network, such as the Internet, a local area network (LAN), a wide area (WAN), a cellular communications network or the like.

System memory 2020 may be configured to store program instructions 2100 and/or data 2110. Program instructions 2100 may be executable by a processor (e.g., one or more of processors 2010a-2010n) to implement one or more embodiments of the present technique. Instructions 2100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 2020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 2020 may include a non-transitory computer readable storage medium may have program instructions stored thereon that are executable by a computer processor (e.g., one or more of processors 2010a-2010n) to cause the subject matter and the functional operations described herein. A memory (e.g., system memory 2020) may include a single memory device and/or a plurality of memory devices (e.g., distributed memory devices).

I/O interface 2050 may be configured to coordinate I/O traffic between processors 2010a-2010n, system memory 2020, network interface 2040, I/O devices 2060 and/or other peripheral devices. I/O interface 2050 may perform protocol, timing or other data transformations to convert data signals from one component (e.g., system memory 2020) into a format suitable for use by another component (e.g., processors 1010a-1010n). I/O interface 2050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 2000, or multiple computer systems 2000 configured to host different portions or instances of embodiments. Multiple computer systems 2000 may provide for parallel or sequential processing/execution of one or more portions of the techniques described herein.

Those skilled in the art will appreciate that computer system 2000 is merely illustrative and is not intended to limit the scope of the techniques described herein. Computer system 2000 may include any combination of devices and/or software that may perform or otherwise provide for the performance of the techniques described herein. For example, computer system 2000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 2000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to computer system 2000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method, comprising:
reserving a first parking location for parking of a first vehicle;
determining that the first vehicle is parked in a second parking location that is different from the first parking location reserved for parking of the first vehicle;
determining, using a computer, whether the second parking location is available for parking of the first vehicle; and
in response to at least determining that the second parking location is not available for parking of the first vehicle, providing for display of a prompt requesting that the first vehicle be moved to a parking location that is available for parking of the first vehicle.

2. The method of claim 1, wherein providing for display of a prompt requesting that the first vehicle be moved to a parking location that is available for parking of the first vehicle comprises serving content to be displayed via a graphical user interface, the content comprising a message requesting that the first vehicle be moved to an unoccupied and unreserved parking location that is available for parking of the first vehicle.

3. The method of claim 1, where providing for display of a prompt requesting that the first vehicle be moved to a parking location that is available for parking of the first vehicle comprises providing for display of a prompt requesting that the first vehicle be moved to the first parking location that is reserved for parking of the first vehicle.

4. The method of claim 1, wherein reserving a first parking location for a first vehicle comprises reserving a first parking location such that the first parking location is not available to be reserved for parking of other vehicles.

5. The method of claim 1, wherein the first parking location is reserved for parking of the first vehicle in response to receiving a request submitted via a mobile communications device, and wherein determining that the first vehicle is parked in a second parking location comprises determining that the mobile communications device is located at or near the second parking location.

6. The method of claim 1, further comprising:
reserving a third parking location for parking of a second vehicle;
determining that the second vehicle is parked in a fourth parking location that is different from the third parking location reserved for parking of the second vehicle;
determining, using a computer, whether the fourth parking location is available for parking of the second vehicle; and
in response to at least determining that the fourth parking location is available for parking of the second vehicle, providing for display of an option to reserve the fourth parking location for parking of the second vehicle.

7. The method of claim 6, further comprising:
receiving an input indicative of selection of the option to reserve the fourth parking location for parking of the second vehicle; and
in response to at least receiving an input indicative of selection of the option to reserve the fourth parking location for parking of the second vehicle:
reserving the fourth parking location for parking of the second vehicle; and
releasing the reservation of the third parking location for parking of the second vehicle.

8. The method of claim 7, wherein reserving the fourth parking location for parking of the second vehicle comprises reserving the fourth parking location for parking of the second vehicle such that the fourth parking location is not available to be reserved for parking of other vehicles, and wherein releasing the reservation of the third parking location comprises releasing the reservation of the third parking location such that the third parking location is available to be reserved for parking of other vehicles.

9. The method of claim 6, wherein providing for display of an option to reserve the fourth parking location for parking of the second vehicle comprises serving content to be displayed via a graphical display of a user access device, the content comprising a user selectable option to reserve the fourth parking location for parking of the second vehicle.

10. The method of claim 1, comprising:
reserving a third parking location for parking of the first vehicle;
determining that the third parking location is unavailable;
in response to determining that the third parking location is unavailable, releasing the reservation of the third parking location for parking of the first vehicle,
wherein reserving the first parking location for parking of the first vehicle occurs in response to determining that the third parking location is unavailable.

11. A computer-implemented method, comprising:
receiving a request for navigational assistance to a given location;
determining whether there are one or more parking spaces available at a parking facility associated with the given location, the parking facility allowing for reservation for parking of a vehicle within an available parking space prior to arrival of the vehicle at the location; and
in response to at least determining that there is one or more parking spaces available at the parking facility, providing for display of an option to reserve at least one of the one or more parking spaces determined to be available at the parking facility.

12. The method of claim 11, wherein providing for display of an option to reserve at least one of the one or more parking spaces determined to be available at the parking facility comprises serving content to be displayed via a graphical user interface, the content comprising an option to reserve at least one of the one or more parking spaces determined to be available at the parking facility.

13. The method of claim 11, wherein determining whether there are one or more parking spaces available at a parking facility associated with the given location comprises determining whether there are one or more parking spaces available at the parking facility that are unoccupied and unreserved.

14. The method of claim 11, wherein determining that there are one or more parking spaces available at the parking facility comprises determining that there are a plurality of parking spaces available at the parking facility, and wherein the option to reserve at least one of the one or more parking spaces determined to be available at the parking facility comprises an option to select, from a listing of two or more of the plurality of parking spaces determined to be available at the parking facility, one of the plurality of parking space to reserve.

15. The method of claim 11, further comprising:
receiving a selection of one of the one or more parking spaces determined to be available at the parking facility;
reserving the parking space selected; and
providing navigational assistance to the parking space selected.

16. The method of claim 15, further comprising:
monitoring whether or not the parking space selected remains available;
determining that the parking space selected is not available; and
in response to at least determining that the parking space selected is not available, determining whether there are one or more other parking spaces available at the parking facility; and
in response to determining that there are one or more other parking spaces available at the parking facility:
reserving one of the one or more other parking spaces determined to be available at the parking facility; and
providing navigational assistance to the other parking space reserved.

17. The method of claim 15, further comprising:
monitoring whether or not the parking space selected remains available;
determining that the parking space selected is not available; and
in response to at least determining that the parking space selected is not available, determining whether there are one or more other parking spaces are available at the parking facility; and
in response to determining that there is not one or more parking spaces available at the parking facility, providing navigational assistance to the parking facility in place of navigational assistance to the parking space selected.

18. The method of claim 11, further comprising:
receiving a set of one or more user defined parking preferences,
wherein determining whether there are one or more parking spaces available at a parking facility associated with the given location comprises determining whether there are one or more parking spaces available at a parking facility associated with the given location that corresponds to the user defined parking space preferences.

19. A computer-implemented method, comprising:
receiving, from a mobile communications device, an indication that a vehicle is parked in a parking space of a parking facility;
determining that a fee has been paid to entitle parking of the vehicle within the parking space until a parking expiration time;
determining a parking expiration alert time, the parking expiration alert time occurring a given amount of time prior to the parking expiration time;
determining that a current time is equal to or greater than the parking expiration time; and
in response to determining that a current time is equal to or greater than the parking expiration time, providing for display via the mobile communications device, a parking expiration alert indicative of the parking expiration time and providing an option to authorize a payment of an additional fee to entitle parking of the vehicle within the parking space until an extended parking expiration time that is later then the parking expiration time.

20. The method of claim 19, further comprising:
receiving, from the mobile communications device, a request for navigational assistance to the parking space; and
serving, for display via the mobile communications device, content comprising a navigational map for providing navigational assistance to the parking space.
